(19) United States
(12) Patent Application Publication
(10) Pub. No.: US 2006/0021560 A1
(43) Pub. Date: Feb. 2, 2006

(54) Tail fairing designed with features for fast installation and/or for suppression of vortices addition between fairings, apparatus incorporating such fairings, methods of making and using such fairings and apparatus, and methods of installing such fairings

(76) Inventors: David W. McMillan, Deer Park, TX (US); Donald W. Allen, Richmond, TX (US); Dean L. Henning, Needville, TX (US); Stephan P. Armstrong, Houston, TX (US)

Correspondence Address: SHELL OIL COMPANY;Legal Department-Intellectual Property, One Shell Plaza, 47th Floor, 910 Louisiana Street, Houston, TX, 77002, US

(21) Appl. No.: 10/839,781

(22) Filed: May 4, 2004

Related U.S. Application Data
(60) Provisional application No. 60/567,692, filed on May 2, 2004.

(51) Int. Cl. B64C 1/38

(52) U.S. Cl. 114/221 R; 244/130

(57) ABSTRACT

Tail fairings designed with features for fast installation and/or for suppression of vortices addition between fairings, apparatus incorporating such fairings, methods of making and using such fairings and apparatus, and methods of installing such fairings.

### BACKGROUND OF THE INVENTION

1. Field of the Invention

The present invention relates to apparatus, systems and methods for reducing vortex-induced-vibrations (“VIV”), current drag, low frequency drift oscillations due to random waves, and low frequency wind induced resonant oscillations. In another aspect, the present invention relates to apparatus, systems and methods comprising enhancement of VIV suppression devices for control of vortex-induced-vibrations, current drag, low frequency drift oscillations due to random waves, and low frequency wind induced resonant oscillations. In even another aspect, the present invention relates to apparatus, systems and methods comprising modified and improved performance fairings for reducing VIV, current drag, low frequency drift oscillations due to random waves, and low frequency wind-induced resonant oscillations. In still another aspect, the present invention relates to tail fairings designed with features for fast installation and/or for suppression of vortices addition between fairing, apparatus incorporating such fairings, methods of making and using such fairings and apparatus, and methods of installing such fairings.

2. Description of the Related Art

When a bluff body, such as a cylinder, in a fluid environment is subjected to a current in the fluid, it is possible for the body to experience vortex-induced vibrations (VIV). These vibrations are caused by oscillating hydrodynamic forces on the surface which can cause substantial vibrations of the structure, especially if the forcing frequency is at or near a structural natural frequency. The vibrations are largest in the direction transverse to flow, however, in-line vibrations can also cause stresses which are sometimes larger than those in the transverse direction.

Drilling for and/or producing hydrocarbons or the like from subterranean deposits which exist under a body of water exposes underwater drilling and production equipment to water currents and the possibility of VIV. Equipment exposed to VIV includes the smaller tubes and cables of a riser system, umbilical elements, mooring lines, anchoring tendons, marine risers, lateral pipelines, the larger underwater cylinders of the hull of a minispar or spar floating production system.

There are generally two kinds of water current induced stresses to which all the elements of a riser system are exposed. The first kind of stress as mentioned above is caused by vortex-induced alternating forces that vibrate the underwater structure in a direction perpendicular to the direction of the current. These are referred to as vortex-induced vibrations (VIV). When water flows past the structure, vortices are alternately shed from each side of the structure. This produces a fluctuating force on the structure transverse to the current. If the frequency of this harmonic load is near the resonant frequency of the structure, large vibrations transverse to the current can occur. These vibrations can, depending on the stiffness and the strength of the structure and any welds, lead to unacceptably short fatigue lives. Stresses caused by high current conditions have been known to cause structures such as risers to break apart and fall to the ocean floor.

The second type of stress is caused by drag forces which push the structure in the direction of the current due to the structure's resistance to fluid flow. The drag forces are amplified by vortex induced vibrations of the structure. For instance, a riser pipe which is vibrating due to vortex shedding will disrupt the flow of water around it more so than a stationary riser. This results in greater energy transfer from the current to the riser, and hence more drag.

Many methods have been developed to reduce vibrations of subsea structures. Some of these methods operate by modifying the boundary layer of the flow around the structure to prevent the correlation of vortex shedding along the length of the structure. Examples of such methods include the use of helical strakes around a structure, or axial rod shrouds and perforated shrouds. Other methods to reduce vibrations caused by vortex shedding from subsea structures operate by stabilization of the wake. These methods include use of fairings, wake splitters and flags.

While these conventional suppression apparatus and methods are widely used and adequate in suppressing fluid current effects on a riser element, often times undesired current effects still occur. Specifically, when a plurality of fairings are utilized, aligned vertically relative to each other along a riser, the vortices formed
adjacent one fairing may combine with the vortices formed adjacent fairings that vertically above or below the fairing, to create a vertically combined vortices that can act in unison upon the riser.

It is also quite laborious to install a fairing.

Thus, there is a need in the art for apparatus, systems and methods for suppressing VIV and reducing drag of a marine element.

There is another need in the art for apparatus, systems and methods for suppressing VIV and reducing drag of a marine element in which the vertical addition of vortices is eliminated or reduced.

There is even another need in the art for apparatus, systems and methods for suppressing VIV and reducing drag of a marine element, which are easier and quicker to install.

These and other needs of the present invention will become apparent to those of skill in the art upon review of this specification, including its drawings and claims.

### SUMMARY OF THE INVENTION

It is an object of the present invention to provide for for apparatus, systems and methods for suppressing VIV and reducing drag of a marine element.

It is another object of the present invention to provide for apparatus, systems and methods for suppressing VIV and reducing drag of a marine element in which the vertical addition of vortices is eliminated or reduced.

It is even another object of the present invention to provide for apparatus, systems and methods for suppressing VIV and reducing drag of a marine element, which are easier and quicker to install.

These and other objects of the present invention will become apparent to those of skill in the art upon review of this specification, including its drawings and claims.

According to one embodiment of the present invention, there is provided an apparatus for controlling drag and vortex-induced vibration. The apparatus includes a fairing body suitable for abutting against a cylindrical marine element. The apparatus also includes a first half of a first mating connector, and a first half of a second mating connector both supported by the faring body. The apparatus also includes a strap having a second half of the first mating connector, and a second half of the second mating connector, wherein the first half and second half of the first mating connector a suitable for forming a connection, and wherein the first half and second half of the second mating connector a suitable for forming a connection.

According to another embodiment of the present invention, there is provided a system for controlling drag and vortex-induced vibration. The system includes a substantially cylindrical marine element and a fairing body abutted against the marine element. On the fairing are a first half of a first mating connector, and a first half of a second mating connector supported by the faring body. The system also includes a strap comprising a second half of the first mating connector forming a connection with the first half of the first mating connector, and a second half of the second mating connector forming a connection with the first half of the second mating, and wherein the strap and the fairing circle the marine element.

According to even another embodiment of the present invention there is provided a method for controlling drag and vortex-induced vibration on a substantially cylindrical marine element. The method includes abutting a fairing body against the marine element, wherein the fairing body comprises a first half of a first mating connector, and a first half of a second mating connector supported by the faring body. The method also includes positioning strap around the marine element, wherein the strap comprises a second half of the first mating, and a second half of the second mating connector. The mehtod also includes connecting the first and second halves of the first mating connector, and connecting the first and second halves of the second mating connector.

According to still another embodiment of the present invention, there is provided an apparatus for controlling drag and vortex-induced vibration. The apparatus includes a fairing body suitable for abutting against a cylindrical marine element, and a ledge member extending away the fairing body. In an alternative embodiment, the ledge can be replaced by grooves on the surface of the fairing body.

According to yet another embodiment of the present invention, there is provided a system for controlling drag and vortex-induced vibration. The system comprises a substantially cylindrical marine element, and a fairing body abutted against the marine element, wherein the fairing body comprises a ledge member extending away the fairing body. In an alternative embodiment, the ledge can be replaced by grooves on the surface of the fairing body.

According to even still another embodiment of the present invention, there is provided a method for controlling drag and vortex-induced vibration on a substantially cylindrical marine element. The method includes abutting a fairing body against the marine element, wherein the fairing body comprises a ledge member extending away the fairing body. In an alternative embodiment, the ledge can be replaced by grooves on the surface of the fairing body.

### BRIEF DESCRIPTION OF THE DRAWINGS

FIG. 1 is a top view of riser 100 on which is mounted a number of fairings 103 each having a leading edge 101 and a tail 104, with current 106 diverted around as diverted current 108 and then converging current 109.

FIG. 2 is a side view of riser 100 of FIG. 1 on which is mounted a number of fairings 103 each having a leading edge 101 and a tail 104.

FIG. 3 is a side view of riser 100, showing a number of non-limiting examples of different embodiments 201A-F of the present invention which may be utilized.

FIG. 4 is a top view of riser 100 on which is mounted a number of fairings 103 each having a leading edge 101 and a tail 104, and showing ledge 201A, and point 220 where the current begins to converge.

FIGS. 5A, 6 and 7, show top, isolated-side, and side views of riser 100 and fast installation fairing 300 of the present invention.

FIG. 5B an isolated view showing detail of mating connector 310.

FIGS. 8 and 9 are top and side views of riser 100 and another embodiment of fast installation fairing 300 of the present invention.

FIGS. 10-13 show an alternate construction for the present invention.

FIGS. 14, 15A, 15B, and 16-22, are figures showing details for mating connector 310.

FIG. 23 is an alternate embodiment for strap 305.

FIGS. 24A, 25A, 26A, and 27A, show respectively, the experimental pipe/fairing arrangement for the data of FIGS. 24B, 25B, 26B, and 27B.

### DETAILED DESCRIPTION OF THE INVENTION

“Suppression of Vortices Addition Between Fairing”

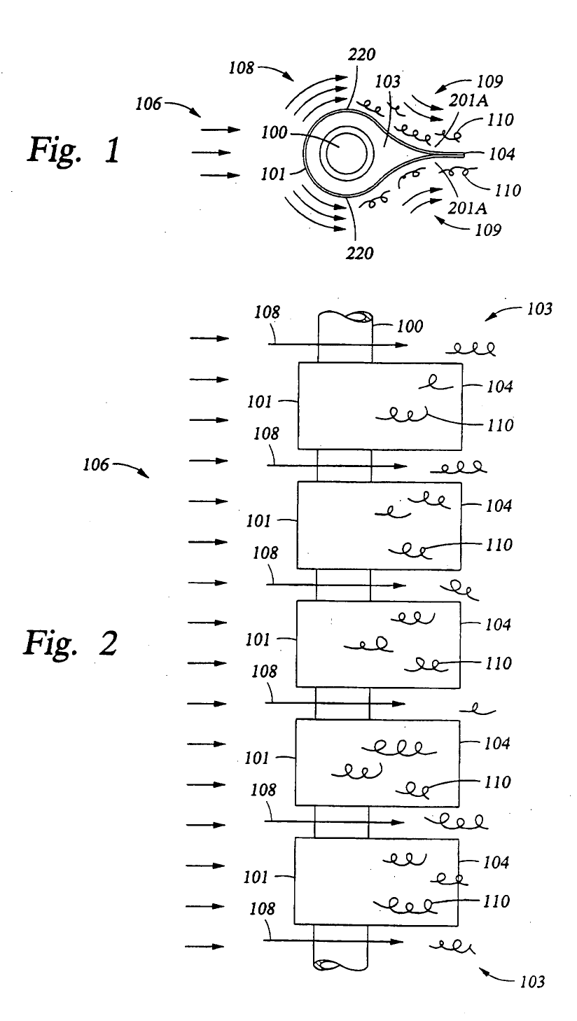

The problem of vortices combining between vertically adjacent fairings is best understood by reference to FIGS. 1 and 2. Referring now to FIGS. 1 and 2, there are shown top and side views of riser 100 on which are mounted a number of fairings 103 each having a leading edge 101 and a tail 104. Current 106 is diverted around as diverted current 108 and then converging current 109. Vortices 110 are created by current flowing around riser 100/fairing 103.

Unfortunately, the various vortices 110 formed on the various fairings 103, have a tendency to combine vertically (vertical vortices addition), across 2, 3 or more fairings, and can create a large combined vertically integral vortices that can act upon riser 100.

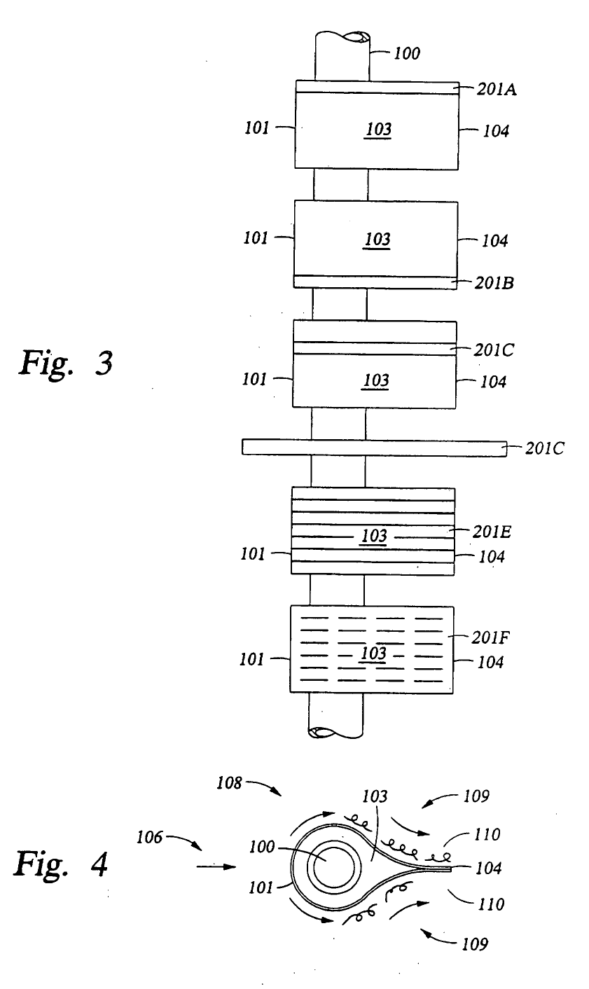

The present invention provides some sort of resistance to reduce/eliminate the vertical vortices addition. Referring now to FIG. 3, there are show a number of non-limiting examples of different embodiments 201A-F of the present invention which may be utilized.

A number of the embodiments shown herein utilize a ledge/fin/wing that extends radially out sufficiently beyond the main body of the fairing 103 to reduce/eliminate vertical vortices addition.

One embodiment is ledge or fin 201A positioned at the top of the fairing body and extending horizontally away from the main body of fairing 103 to reduce/eliminate the vertical vortices addition.

Ledge or fin 201B is similar except positioned at the bottom of fairing 103.

Ledge or fin 201C is similar except positioned on the fairing body somewhere between the top and bottom.

Ledge or fin 201D is positioned between two fairings 103 and mounted on riser 100, and extends radially away from riser 100 sufficiently to reduce/eliminate the vertical vortices addition.

Ledge/fins 201A, 201B, 201C, 201D, all should extend radially away from riser 100 sufficient to extend into vortices 106 forming alongside fairing 103. These ledge/fins should adequately disrupt vertical vortices addition.

Other embodiments shown herein utilize modifications to the surface of the fairing that interfere with vertical fluid flow, and thus reduce/eliminate vertical vortices addition. Such surface modifications are generally in the form of grooves 201E and/or 201F that tend to promote channeling of current in the horizontal direction. Generally any suitable arrangement of grooves may be utilized. Preferably, such grooves would comprises a number of horizontal parallel grooves each of which may or may not span all of the body of fairing 103. It is also envisioned that some/all of adjacent parallel grooves could be connected by a groove running between them, preferably perpendicularly, although any suitable angle can be utilized. The grooves can have suitable cross-sectional shape, non-limiting examples includes semi-circular, semi-oval, v-groove, U-groove, n-sided groove (with equal or unequal sides, with equal or unequal angles between sides), and any suitable curvalinear groove shape. Groove depth will be subject to design criteria for the currents encountered. Groove depth can be constant both between grooves and/or within a single groove, and/or can vary, both between grooves and/or within a single groove.

The present invention also anticipates that a fairing can be modified with both the ledge/fin and grooves.

In theory vortices formation can occur at the leading edge 101 of fairing 103. However, the reality is that vortices formation of concern generally occurs at some point along the fairing where the current tends to diverge. This is at or past the point where the fairing profile begins to allow for current divergence, shown in FIG. 4 as point 220.

While the fins/grooves of the present invention can span the entire perimeter of fairing 103, such fins/grooves are believed by the inventors to have less value prior to large amounts of vortices formation. While difference current scenarios will dictate different fin/groove design, the inventors prefer use of the fins/grooves along the perimeter of fairing 103 where troublesome vortices formation occurs, which can be readily obtained by modeling or actually observing the riser or like diameter object in the current of interest. As an easy design criteria, use of the fins/grooves from this point 220 to the tail is preferred.

However, it is not required that the inventive fins/grooves be vertically interjected between all vortices, any those deemed to be of concern should they add vertically with like vortices positioned vertically above and below.

It is anticipated, the one or more fins/ledges, generally parallel, can be utilized. To create a channeling effect, a plurality of parallel fins/ledges may be utilized.

Most conveniently, the fin/ledge will be oriented in a plane normal to the elongated axis of riser or other cylindrical marine element. However, the fin/ledge may be oriented at other angles, as long as it extends radially away from the riser and can adequately disrupt vertical vortices addition. It is preferred however, that the fin/ledge be oriented to minimize interference with the current flow. That is, it should be oriented such that the up stream and down stream edge of the fin/ledge is in a plane parallel with the flow of the current.

It is also not necessary that the fin/ledge be flat, it can be any shape that adequately disrupt vertical vortices addition, and does not unduly interfere with the current flow. For example, an elongated member with a cross-sectional “U” shape could be attached to the fairing, provided that it was oriented such that its elonated axis was parallel with the flow.

“Fast Installation Feature”

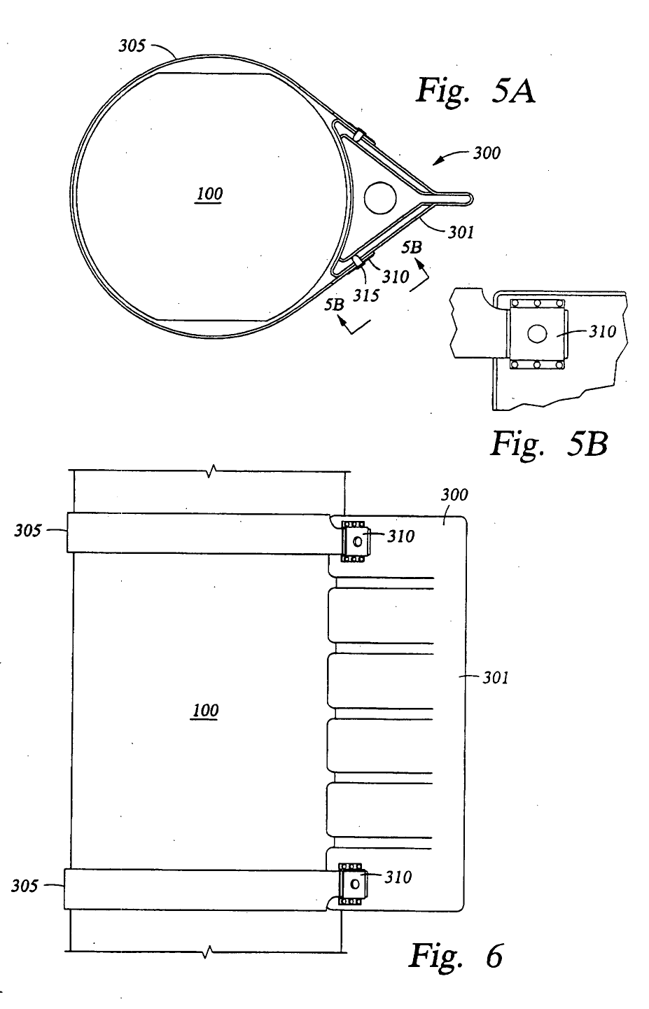

The “Fast Installation” feature of this invention consists of methods of manufacturing tail sections as well as unique details for other components. Referring now to FIGS. 5A, 6, and 7, there are shown top, isolated-side, side views of riser 100 and one embodiment of fast installation fairing 300 of the present invention, with FIG. 5B showing detail of mating connector 310.

In the embodiment as shown in FIGS. 5A and 6, has a tail which is manufactured by a process know as rotational molding. There are many materials which can be used to rotationally mold the tail, including thermoplastics and thermosets. A non-limiting example of a suitable material includes high density polyethylene. There are holes in each end of the tail which allow the tail to flood, thus eliminating problems that would be caused by hydrostatic pressure as the riser goes deeper into the water. The tail has ribs to structurally reinforce the tail. The holes in the ends also allow for the installation of internal hardware to be discussed later.

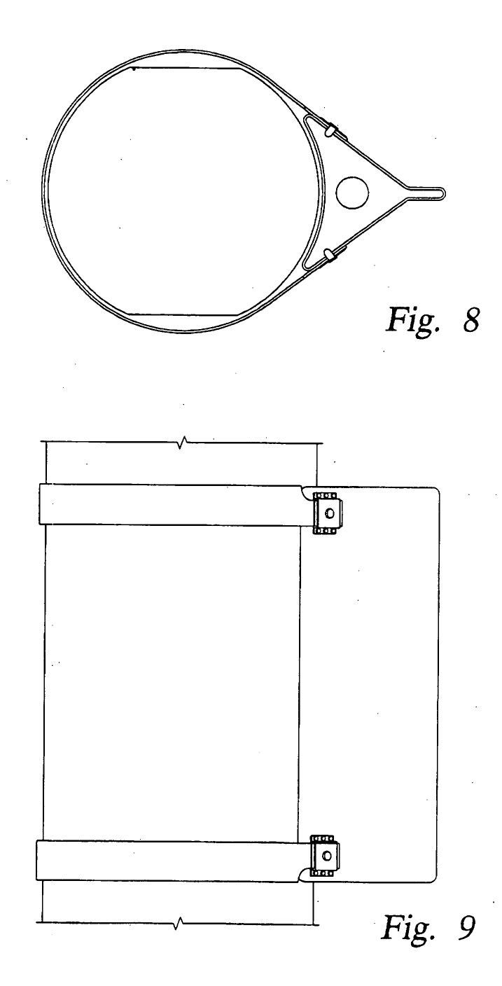

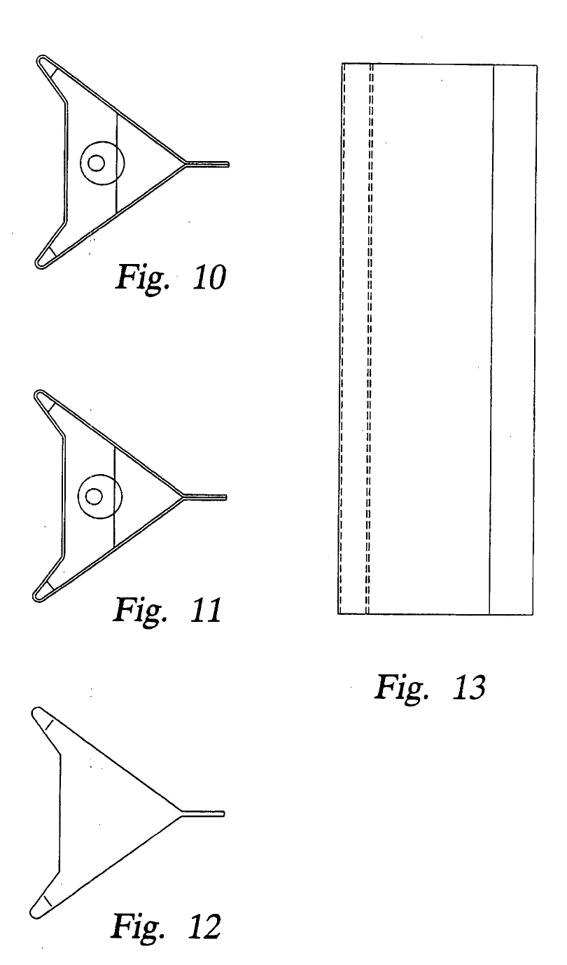

FIGS. 8-9 are top and side views of riser 100 and another embodiment of fast installation fairing 300 of the present invention, with further details provided in FIGS. 10-13. This embodiment provides an alternate construction for the tail, which would be bending or forming of a material such as ABS to make the outer profile and plates welded in the ends and internally for reinforcements. These materials can also be solvent-welded as opposed to heat-welding, or a combination of attachment methods can be utilized.

Fairing 300 comprises a main fairing body 301 and connector straps 305.

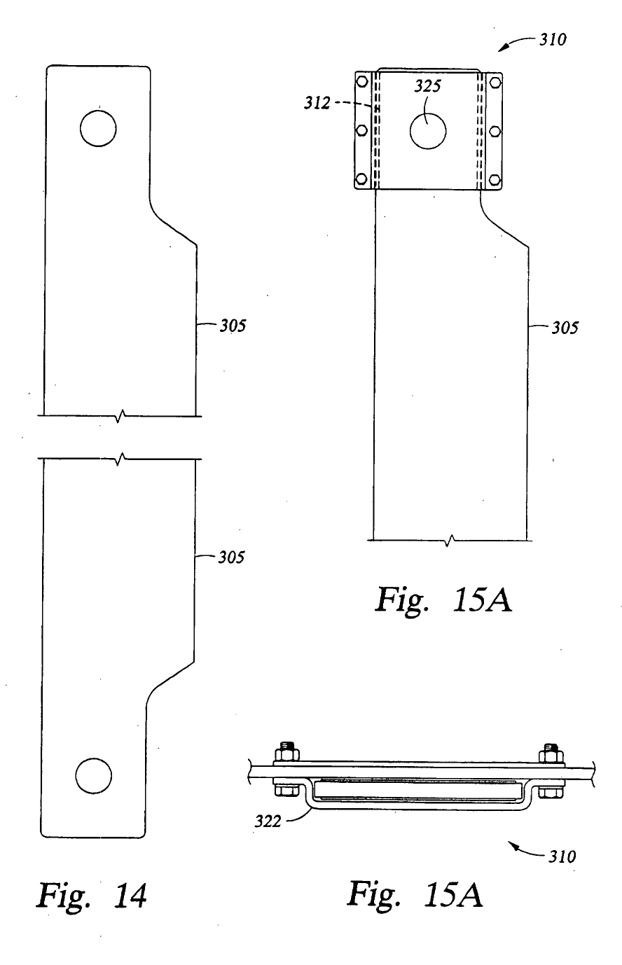

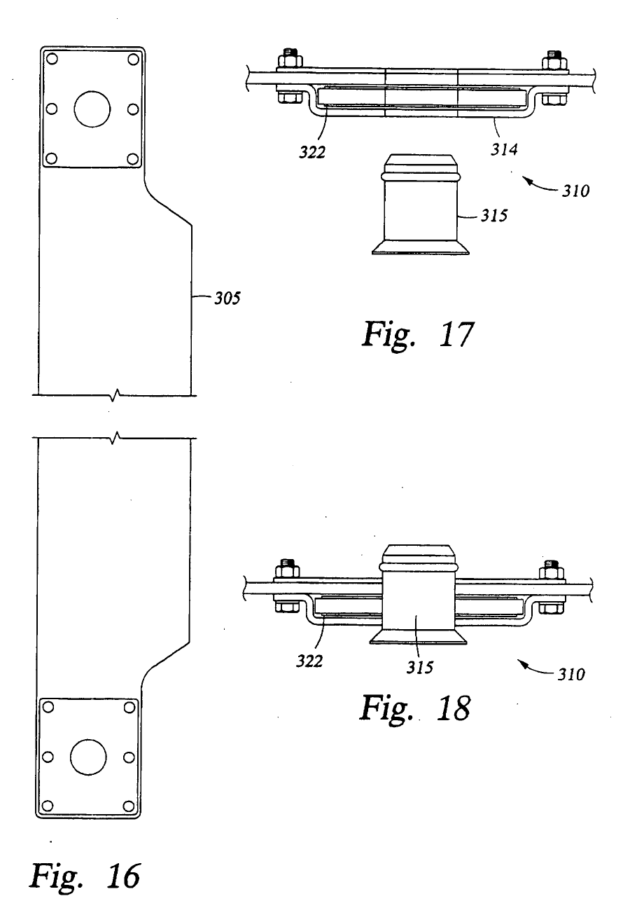

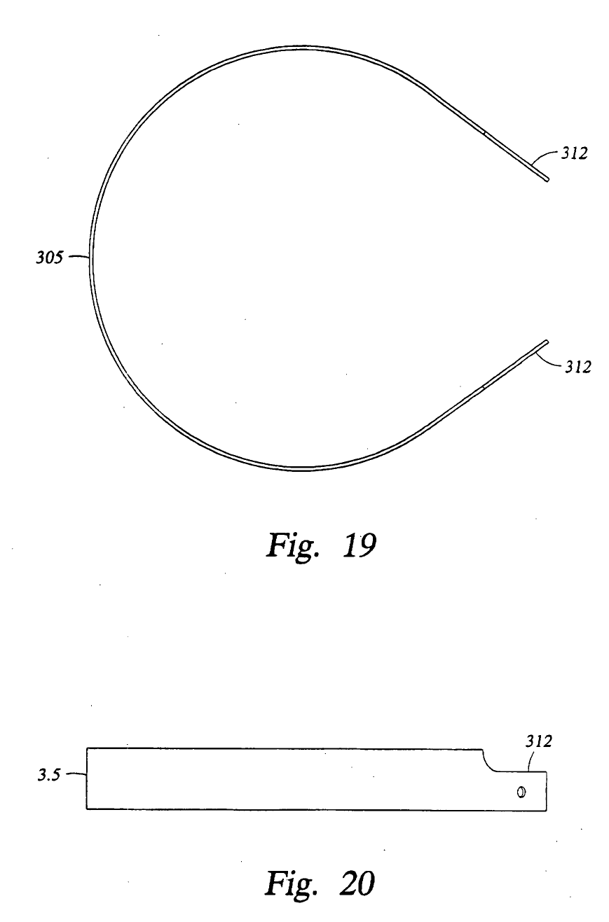

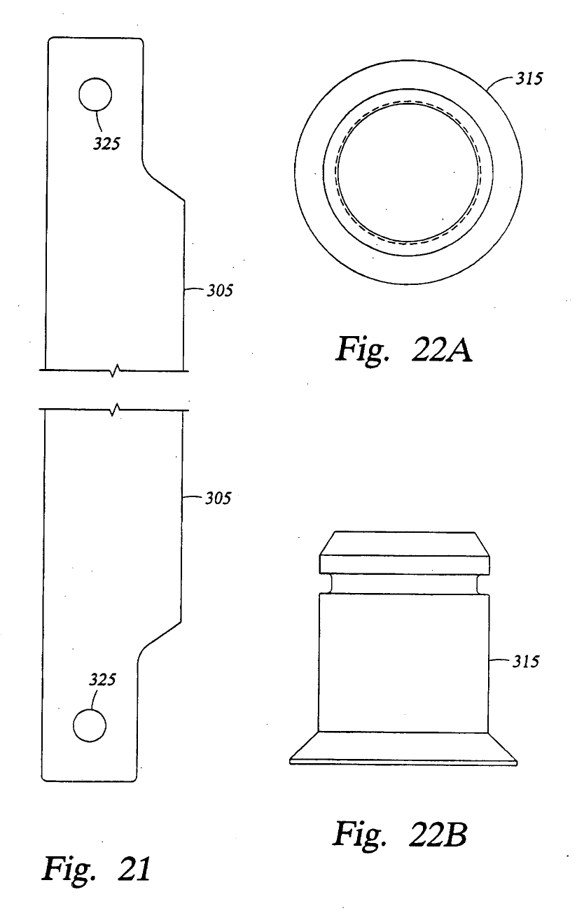

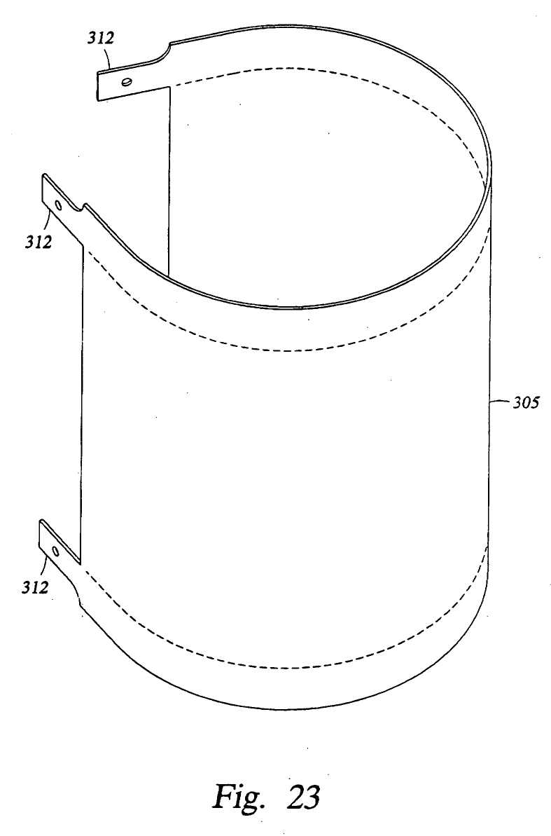

Mating connectors 310 consist of a first half 312 and a second half 314 of a mating connector. Referring additionally to FIGS. 14, 15A, 15B, and 16-22, there are provided details for mating connector 310. One half of connector 310 is positioned on the fairing body 301 and the other half on strap 305, unless the operation, installation or integrity of the connector is effected, it shouldn't matter which half is positioned on fairing body 301 and strap 305. In the embodiment as shown, a connector half receiving slot 322 is formed on fairing body 305 into which during installation of the fairing is placed connector half 312. A locking pin 315 is inserted thru pin slot 325 to secure connector 310 together. Of course, any suitable type of mating locking mechanism may be utilized, with easy to operate, self locking mechanisms preferred.

Still referring to FIGS. 14, 15A, 15B, and 16-22, the method of providing hardware for quick attachment of straps to hold the tail section onto the riser is easily explained. In this design there are four attachment points on the outer surface of the tail section. In this design the attachment points are template drilled, providing a center pin hole and bolt or rivet attachment holes. There is a reinforcing plate on the inside and a pocket plate on the outside. These are aligned and bolted or riveted into place. These materials can be made of many materials, including stainless steel or various plastics. The four “pockets” on this design form the means by which the straps can be attached. The strap can consist of a formed metal band or, in this case a piece of thermally formed HDPE or other non-metallic material. This strap could also be laminated and reinforced. The strap in this design is reinforced on each end with light guage stainless steel plates which are riveted to form one piece. The same pin hole exists on each end.

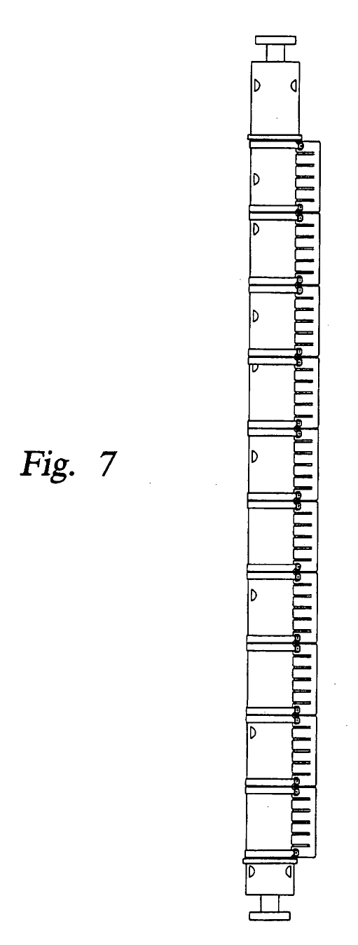

Referring again to FIG. 7, there is shown a typical drilling riser joint with buoyancy modules attached. This drawing show a support collar at the top and bottom of the joint to support the tail sections. The tail consists of a lightweight nonmetallic material.

In this application, the tail is placed against the buoyancy module on the riser. One end of a strap is inserted into a pocket on the tail. A pin with an oring or grommet is inserted through the pin hole. The oring or grommet forms a limited amount of interference when inserted, providing a means to keep the pin from falling out. The pin is pushed in until the oring or grommet passes through the inner reinforcing plate. The pin can be attached to the strap with a chain or lanyard to prevent dropping of the pins. The strap goes around the buoyancy module and the opposite end is attached with a pin. The second or additional strap(s) are attached in the same manner. An entire joint can be covered by “stacking” of the tail assemblies. It is anticipated that an experienced crew would be able to install this design in 30 seconds to a minute, as compared to several minutes on current state-of-the-art suppression devices. Removal is done by pulling the pins with a forked device, removing the straps, and lifting the tail off the riser.

It may be possible to stabilize the fairing with one strap connected at two points. Preferably, however, either two or more straps will be utilized, or a one strap with more than two connection points is utilized.

As another embodiment, the tails may be connected together in groups. For example, three in a group and placing a collar between each group. This will stabilize each group of fairings when going through the water column. The net result of this is that the group will weathervane as a group and the straps end up being only tension members. Hence, the straps do not have to be aligned axially with the top and bottom of the tail, but can be down a short distance from the end of the tail.

### EXAMPLES

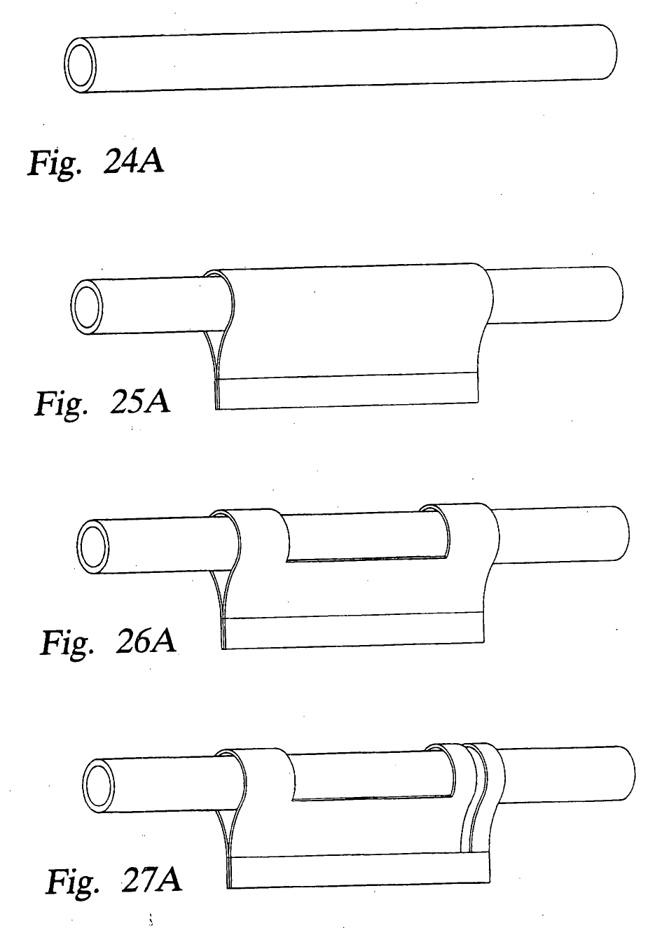

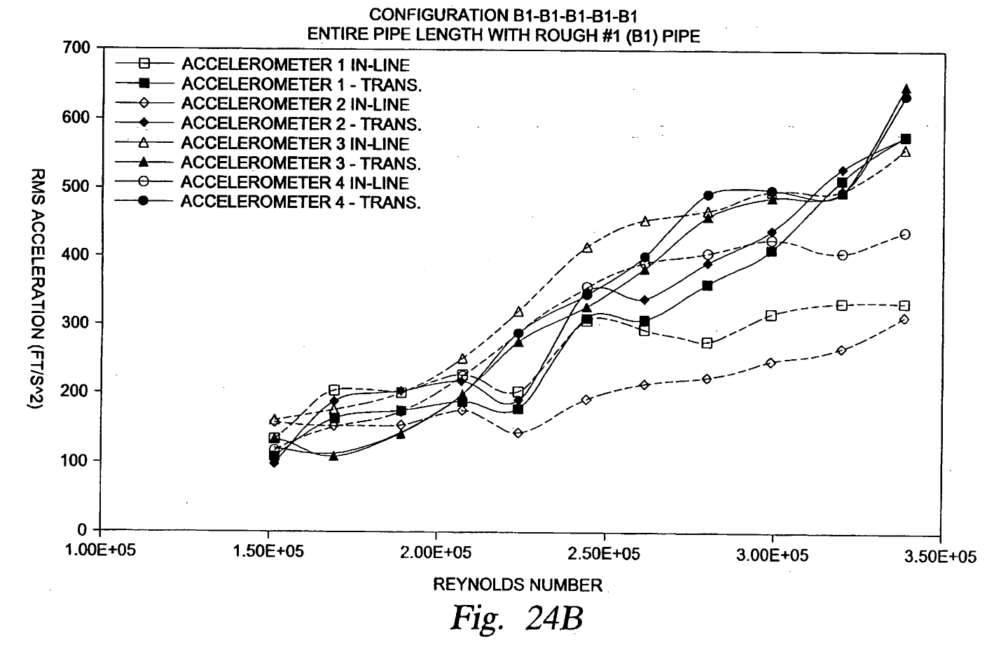

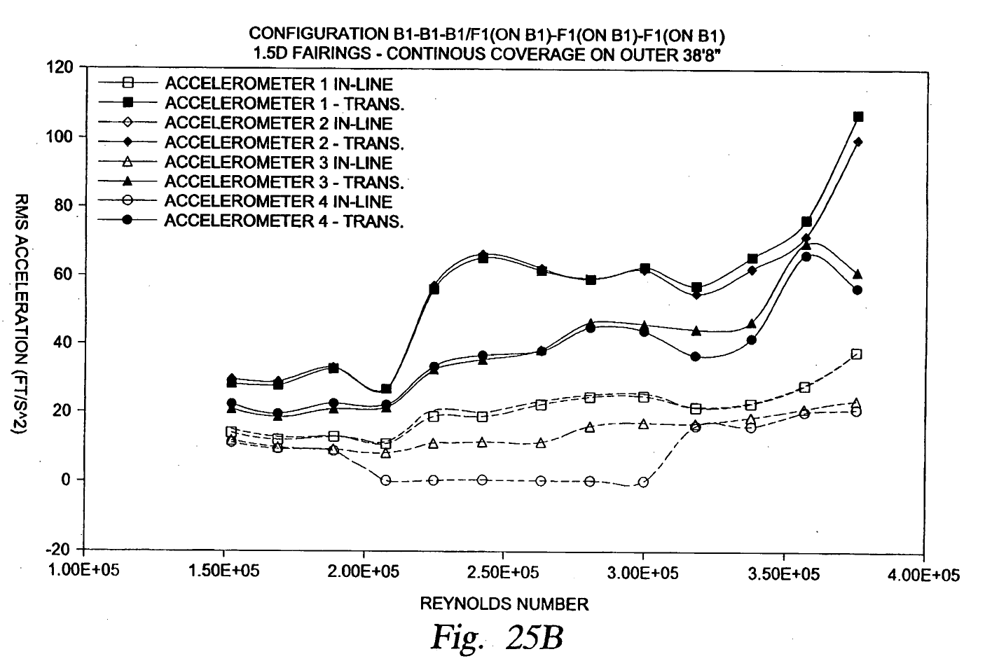

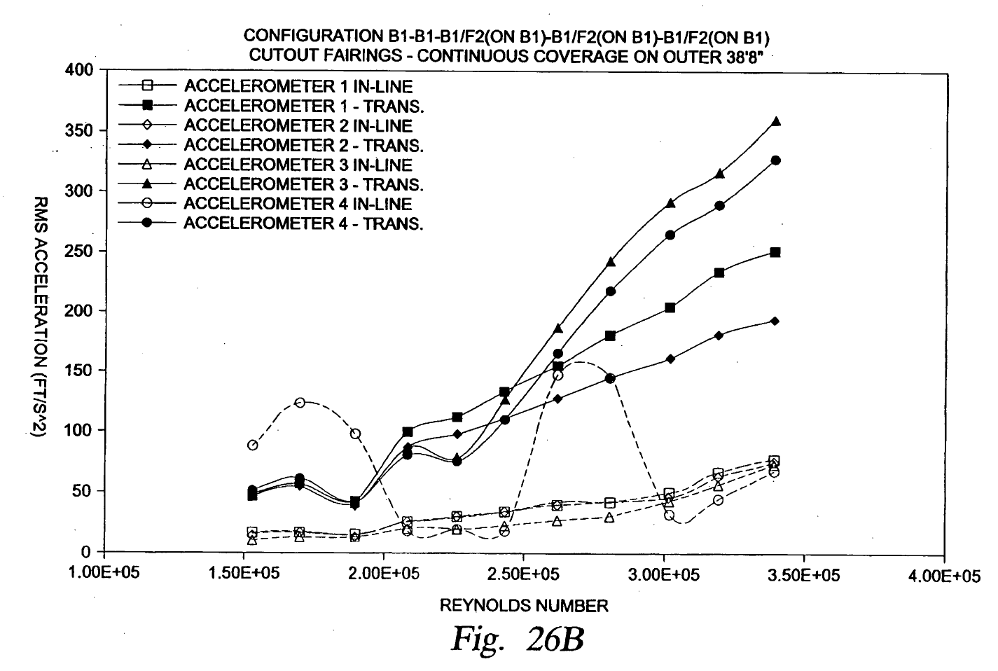

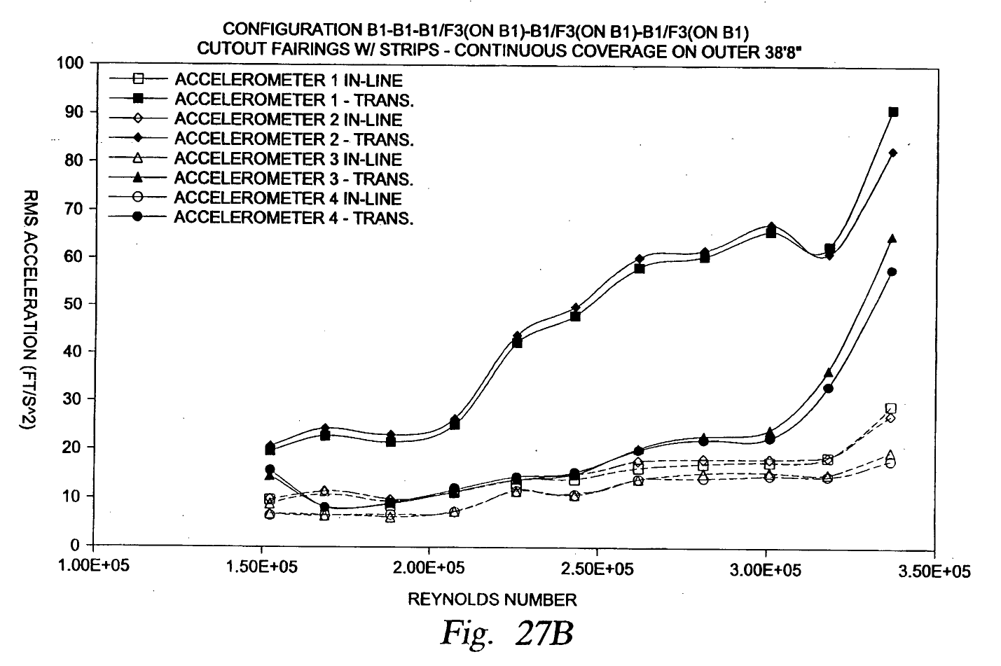

Experiments were conducted of models in fluid tanks. FIGS. 24A, 25A, 26A, and 27A, show respectively, the experimental pipe/fairing arrangement for the data of FIGS. 24B, 25B, 26B, and 27B.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

We claim:

1. An apparatus for controlling drag and vortex-induced vibration, comprising:
a fairing body suitable for abutting against a cylindrical marine element;
a first half of a first mating connector, and a first half of a second mating connector supported by the faring body;
a strap having a second half of the first mating connector, and a second half of the second mating connector, wherein the first half and second half of the first mating connector a suitable for forming a connection, and wherein the first half and second half of the second mating connector a suitable for forming a connection.

2. A system for controlling drag and vortex-induced vibration, comprising:
a substantially cylindrical marine element;
a fairing body abutted against the marine element, and comprising a first half of a first mating connector, and a first half of a second mating connector supported by the faring body;
a strap comprising a second half of the first mating connector forming a connection with the first half of the first mating connector, and a second half of the second mating connector forming a connection with the first half of the second mating, and wherein the strap and the fairing circle the marine element.

3. A method for controlling drag and vortex-induced vibration on a substantially cylindrical marine element, the method comprising;
abutting a fairing body against the marine element, wherein the fairing body comprises a first half of a first mating connector, and a first half of a second mating connector supported by the faring body;
positioning strap around the marine element, wherein the strap comprises a second half of the first mating, and a second half of the second mating connector; and
connecting the first and second halves of the first mating connector, and connecting the first and second halves of the second mating connector.

4. An apparatus for controlling drag and vortex-induced vibration, comprising:
a fairing body suitable for abutting against a cylindrical marine element; and
a ledge member extending away the fairing body.

5. A system for controlling drag and vortex-induced vibration, comprising:
a substantially cylindrical marine element;
a fairing body abutted against the marine element, wherein the fairing body comprises a ledge member extending away the fairing body.

6. A method for controlling drag and vortex-induced vibration on a substantially cylindrical marine element, the method comprising;
abutting a fairing body against the marine element, wherein the fairing body comprises a ledge member extending away the fairing body.

7. An apparatus for controlling drag and vortex-induced vibration, comprising:
a fairing body suitable for abutting against a cylindrical marine element; and
grooves on the fairing body.
